(19) United States
(12) Patent Application Publication
(10) Pub. No.: US 2001/0002920 A1
(43) Pub. Date: Jun. 7, 2001

(54) Mobile radio communication apparatus and control method for controlling the apparatus

(76) Inventors: Takuya Kanazumi, Hino-shi (JP); Akira Ishikura, Kawasaki-shi (JP)

Correspondence Address: FINNEGAN, HENDERSON, FARABOW, GARRETT &, DUNNER LLP, 1300 I STREET, NW, WASHINGTON, DC, 20005, US

(21) Appl. No.: 09/725,813

(22) Filed: Nov. 30, 2000

(30) Foreign Application Priority Data
Dec. 1, 1999 (JP) 11-341575

(51) Int. Cl. H04L 25/00

(52) U.S. Cl. 375/216

(57) ABSTRACT

A mobile radio communication apparatus having a communication function adaptable to both an analog mode and a digital mode is controlled by a control unit, when it receives from a radio base station a message signal representing that the digital mode is provided. When the strength of the message signal in the analog mode received by a receiving unit from the radio base station is at a predetermined level or higher, a mode of communication services is shifted into the digital mode. When the strength is lower than the predetermined level, the standby status in the analog mode is maintained. Therefore, the mode of communication services is not alternated between the analog mode and the digital mode, with the result that both an outgoing call and an incoming call can be performed successfully even in an unstable service area where a transmitted signal cannot reach the radio base station.

### CROSS-REFERENCE TO RELATED APPLICATIONS

This application is based upon and claims the benefit of priority from the prior Japanese Patent Application No. 11-341575, filed Dec. 1, 1999, the entire contents of which are incorporated herein by reference.

### BACKGROUND OF THE INVENTION

The present invention relates to a mobile radio communication apparatus, such as a car telephone, a portable telephone, or a mobile telephone apparatus, which has a function adaptable to both an analog mode and a digital mode.

Generally, service areas of the analog mode and the CDMA (Code Division Multiple Access) mode, one of the digital modes, are distributed adjacently. More specifically, as shown in FIG. 1, a service area 1 including radio base stations (1a, 1b, 1c, 3 and 6 in FIG. 1) for providing communication services in both the analog mode and the CDMA mode is adjacent to a service area 2 including radio base stations (2a, 2b and 2c in FIG. 1) for providing communication services only in the analog mode. The service area 1 is mainly situated in an urban area and the service area 2 is mainly situated in a suburban area. FIG. 1 shows the service area 1 where communication can be performed by both in CDMA mode and the analog mode and the service area 2 where communication can be performed only in the analog mode. All the radio base stations providing communication services in the CDMA mode also provide communication services in the analog mode.

The radio base station 3 providing the CDMA communication services is adjacent to the service area 2 where communication can be performed only in the analog mode. The radio base station 3 transmits a message signal, representing that the CDMA mode is provided, to a mobile telephone apparatus 4 in a standby status in the analog mode.

FIG. 2 shows a control of the mobile telephone apparatus 4 receiving the aforementioned message signal. FIG. 2 is a flowchart of the control when the mobile telephone apparatus 4 receives the message signal representing that the CDMA mode is provided.

When the power source of the mobile telephone apparatus 4 is turned on (21), the mobile telephone apparatus 4 searches for a control channel in the CDMA mode (22). When the mobile telephone apparatus 4 seizes a control channel, it receives a control signal transmitted over the control channel and executes location registration for registering a location of the mobile radio communication apparatus (23). As a result, if the reception and the location registration are successfully accomplished, the mobile telephone apparatus 4 is put into a standby status in the CDMA mode.

On the other hand, if the reception and the location registration are not successfully accomplished, the mobile telephone apparatus 4 is put into a standby status of the analog mode (25). Thereafter, when the mobile telephone apparatus 4 enters the service area including the radio base station 3 providing the CDMA mode, it is detected whether the mobile telephone apparatus 4 receives from the radio base station 3 the message signal representing that the CDMA mode is provided (26).

If the mobile telephone apparatus 4 receives the aforementioned message signal, the apparatus 4 is regarded as being a state that it enters the service area 1 where the CDMA mode is provided, and searches for a control channel in the CDMA mode (27). Then, the apparatus 4 seizes a control channel, and put into a state for receiving a control signal transmitted over the control channel of the CDMA mode.

FIG. 3 shows a control in the case where failure occurs when the mobile telephone apparatus 4 receives the message signal representing that the CDMA mode is provided. FIG. 3 is a flowchart of the control when a communication mode in the mobile telephone apparatus (in other words, a mode of communication services) is alternated between the CDMA mode and the analog mode without executing location registration in the flow of the control shown in FIG. 2.

During standby in the analog mode (31), the conventional mobile telephone apparatus 4, having a function adaptable to both the analog mode and the CDMA mode, receives from the radio base station 3 a message signal representing that the CDMA mode is provided (32). Thereafter, regardless of the level of the wave strength of the signal received from the radio base station 3, the mobile telephone apparatus 4 is unconditionally shifted to a search for a control channel of the CDMA mode from the standby status in the analog mode (33).

Then, the mobile telephone apparatus 4 receives a control signal transmitted over the control channel in the CDMA mode (34). The mobile telephone apparatus 4 executes location registration to the radio base station 3, in order to register the service area where the apparatus 4 is located, and transmits a location registration message signal to the radio base station 3 (35).

The radio base station 3, which has received the location registration message signal from the mobile telephone apparatus 4, transmits to the mobile telephone apparatus 4 an ACK signal (acknowledge signal) representing that the location registration message signal is correctly received. When the mobile telephone apparatus 4 receives the ACK signal (36), the location registration is completed and the apparatus 4 is put in the standby status in the CDMA mode (37).

There is a transmission or reception unstable service area 7, in which a mobile telephone apparatus 5 can receive a signal from a radio base station 6 during the search of the control channel in the CDMA mode, whereas a wave transmitted from the mobile telephone apparatus 5 cannot reach the base station 6. In the service area 7, even when the mobile telephone apparatus 5 transmits a location registration message signal for executing location registration (35), the radio base station 6 cannot receive the signal. Therefore, no ACK signal is transmitted from the radio base station 6 to the mobile telephone apparatus 5. Therefore, the location registration in the CDMA mode cannot be successfully executed. Hence, the mobile telephone apparatus 5 is switched to the standby status in the analog mode (31) again.

The mobile telephone apparatus 5 placed in the standby state in the analog mode (31) receives from the radio base station 6 a message signal representing that the CDMA mode is provided (32). Then, the apparatus 5 searches again for a control channel in the CDMA mode (33).

As a result, a mode of communication services in the mobile telephone apparatus 5 is alternated between the analog mode and the CDMA mode. Therefore, the location registration cannot be completed and an outgoing call or an incoming call cannot be made.

As described above, when the conventional mobile telephone apparatus having a function adaptable to both the analog mode and the CDMA mode receives in the analog mode a message signal representing that the CDMA mode is provided, a mode of communication services in the conventional apparatus is unconditionally shifted into the CDMA mode. Therefore, in a transmission or reception unstable service area in which the mobile telephone apparatus can receive a signal from a radio base station whereas a wave transmitted from the mobile telephone apparatus cannot reach to the base station, the conventional mobile telephone apparatus has a problem that the mode of communication services is alternated between the analog mode and the CDMA mode and an outgoing call or an incoming call cannot be made.

Moreover, when the mode of communication services is alternated between the analog mode and the CDMA mode, the mobile telephone apparatus transmits a location registration message signal for executing location registration to the radio base station many times. The mobile telephone apparatus requires no little power to transmit the location registration message signal. Therefore, transmission of the location registration message signal many times causes a problem that power consumption of the battery of the mobile telephone apparatus is increased.

### BRIEF SUMMARY OF THE INVENTION

An object of the present invention is to provide a mobile radio communication apparatus in which a mode of communication services is not alternated between an analog mode and a digital mode even in a transmission or reception unstable service area where a wave transmitted from the apparatus does not reach a radio base station, so that both an outgoing call and an incoming call can be performed successfully.

Another object of the present invention is to provide a mobile radio communication system which consumes less power.

According to an aspect of the present invention, there is provided a mobile radio communication apparatus, having a communication function adaptable to both an analog mode and a digital mode, for carrying out communications with radio base stations capable of communicating in at least the analog mode, the apparatus comprising:

signal receiving means for receiving a signal representing that a communication can be carried out in the digital mode from a radio base station capable of communicating in both the analog mode and the digital mode, the signal being received in the analog mode;

detecting means for detecting a strength of the signal received from the radio base station; and

shifting means for shifting a mode of communication services into the digital mode from the analog mode in accordance with the strength, when the message signal is received.

According to another aspect of the present invention, there is provided a control method for controlling a mobile radio communication apparatus having a communication function adaptable to both an analog mode and a digital mode and a function for receiving, from a radio base station in the analog mode, a signal representing that a communication can be carried out in the digital mode, the method comprising the steps of:

detecting a strength of the signal received from the radio base station; and

shifting a mode of communication services into the digital mode from the analog mode in accordance with the strength, when the signal is received.

According to still another aspect of the present invention, there is provided a control method for controlling a mobile radio communication apparatus having a communication function adaptable to both an analog mode and a digital mode and a function for receiving, from a radio base station in the analog mode, a signal representing that a communication can be carried out in the digital mode, the method comprising the steps of:

detecting a strength of the signal received from the radio base station; and

performing a control for transmitting to the radio base station a location registration signal for registering a location of the mobile radio communication apparatus in order to establish a communication in the digital mode in accordance with the strength, when the signal is received.

According to still further aspect of the present invention, there is provided a control method for controlling a mobile radio communication apparatus adaptable to both an analog mode and a digital mode, for carrying out a communication with a radio base station capable of carrying out a communication at least in the analog mode, the method comprising the steps of:

receiving, from the radio base station in the analog mode, a signal representing that a communication can be carried out in the digital mode;

detecting a strength of the signal received from the radio base station; and

shifting a mode of communication services into the digital mode in accordance with the strength, when the signal is received.

Additional objects and advantages of the invention will be set forth in the description which follows, and in part will be obvious from the description, or may be learned by practice of the invention. The objects and advantages of the invention may be realized and obtained by means of the instrumentalities and combinations particularly pointed out hereinafter.

### BRIEF DESCRIPTION OF THE SEVERAL VIEWS OF THE DRAWING

The accompanying drawings, which are incorporated in and constitute a part of the specification, illustrate presently preferred embodiments of the invention, and together with the general description given above and the detailed description of the preferred embodiments given below, serve to explain the principles of the invention.

FIG. 1 is a diagram showing a service area in which communication can be performed in both the CDMA mode and an analog mode and a service area in which communication can be performed only in an analog mode;

FIG. 2 is a flowchart of the control when a mobile telephone apparatus receives a message signal representing that the CDMA mode is provided;

FIG. 3 is a flowchart of the control when a communication mode in a mobile telephone apparatus is alternated between the CDMA mode and the analog mode without executing location registration in the flow of the control shown in FIG. 2;

FIG. 4 is a functional block diagram showing the constitution of a mobile telephone apparatus according to an embodiment of the present invention;

FIG. 5 is a flowchart of the control when the mobile telephone apparatus of the embodiment receives a message signal representing that the CDMA mode is provided; and

FIG. 6 is a diagram showing a display screen of the display unit shown in FIG. 4.

### DETAILED DESCRIPTION OF THE INVENTION

An embodiment of the present invention will be described with reference to the accompanying drawings.

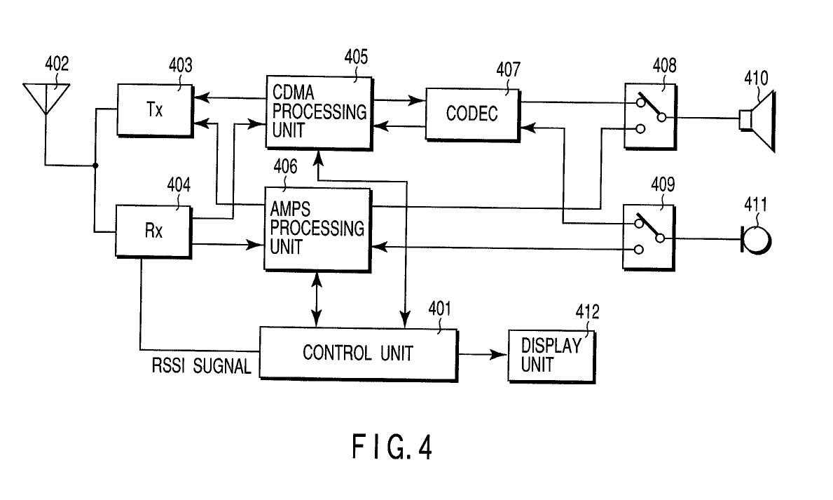

FIG. 4 is a functional block diagram showing the constitution of a mobile telephone apparatus having a communication function adaptable to both an analog mode, for example, the AMPS (Advanced Mobile Phone Service) mode, and a digital mode, for example, the CDMA mode.

As shown in FIG. 4, the mobile telephone apparatus comprises a control unit 401 for controlling the operations of the overall apparatus, an antenna 402 through which a radio signal is transmitted and received, a transmitting unit (TX) 403 for modulating a radio signal, a receiving unit (Rx) 404 for demodulating a radio signal, a CDMA processing unit 405 for processing a signal in a CDMA-mode base band, an AMPS processing unit 406 for processing a signal in an AMPS-mode base band, a CODEC unit 407 for coding and decoding a voice signal in the CDMA mode, selector switches 408 and 409, a loudspeaker 410, a microphone 411 and a display unit 412.

In the mobile telephone apparatus having the constitution described above, when a call is started in the CDMA mode, the selector switches 408 and 409 are switched to the terminals on the CDMA sides (the upper sides of the selector switches 408 and 409). A voice signal input through the microphone 411 is coded by the CODEC unit 407. Then, this coded voice signal is subjected to a spread spectrum process in the CDMA processing unit 405 using a predetermined PN (pseudonoise) code together with a control signal supplied from the control unit 401. This spread voice signal is modulated by the transmitting unit (Tx) 403, and transmitted as a radio signal to a radio base station through the antenna 402.

A radio signal transmitted from a radio base station is received by the antenna 402, and demodulated by the receiving unit (Rx) 404. A voice signal contained in the demodulated radio signal is subjected to a despread spectrum process using a predetermined PN code by the CDMA processing unit 405. This despread voice signal is decoded by the CODEC unit 407 and output through the loudspeaker 410. On the other hand, the control signal contained in the demodulated radio signal is output to the control unit 401. The level of the wave strength of the signal received in the CDMA mode is detected by the despread signal using the predetermined PN signal by the CDMA processing unit 405.

On the other hand, when a call is started in the AMPS mode, the selector switches 408 and 409 are switched to the terminals on the AMPS sides (the lower sides of the selector switches 408 and 409). A voice signal input through the microphone 411 is synthesized with a control signal supplied from the control unit 401 in the AMPS processing unit 406. Then, this synthesized voice signal is modulated by the transmitting unit (Tx) 403, and transmitted as a radio signal to a radio base station through the antenna 402.

A radio signal transmitted from a radio base station is received by the antenna 402, and demodulated by the receiving unit (Rx) 404. A voice signal and a control signal contained in this demodulated radio signal are divided into the voice signal and the control signal by the AMPS processing unit 406. The voice signal is output from the loudspeaker 410 and the controls signal is output to the control unit 401. The level of the wave strength of the signal received in the AMPS mode is detected by an RSSI (received signal strength indicator) signal output from the receiving unit (Rx) 404 to the control unit 401.

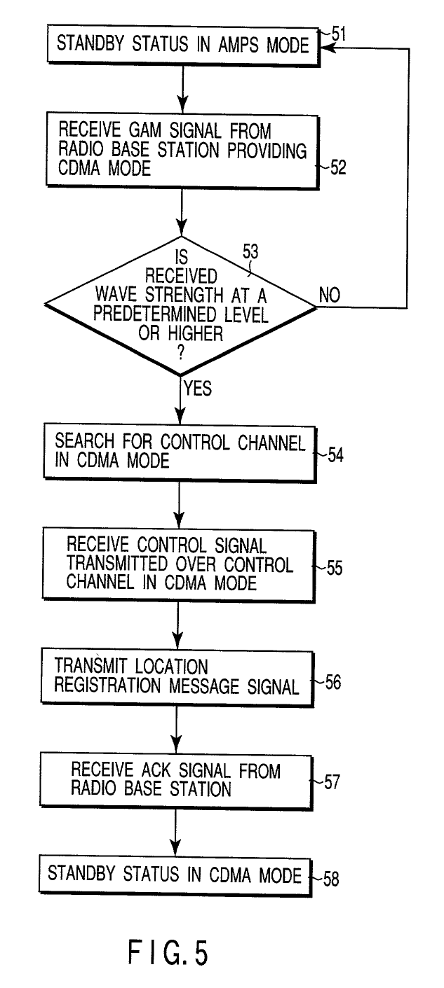

A control operation of the control unit 401, in the case where the mobile telephone apparatus receives a message signal representing that the CDMA mode is provided in the standby status in the AMPS mode, will be described with reference to the flowchart of FIG. 5 and a display status of the display unit 412 shown in FIG. 6. The flowchart shown in FIG. 5 shows the control in the case where the mobile telephone apparatus of this embodiment receives the message signal representing that the CDMA mode is provided.

It is assumed that the mobile telephone apparatus is placed in the standby status in the AMPS mode (51). In general, all radio base stations are adapted to the AMPS mode, even if they are not adapted to the CDMA mode. Therefore, when the mobile telephone apparatus is started up, the apparatus is generally placed in the standby status in the AMPS mode. In the standby states, when the mobile telephone apparatus receives a GAM (Global Access Message) signal from a radio base station providing the CDMA mode (52), at first the level of the wave strength of the signal received in the AMPS mode in the base station is detected (53). The GAM signal is a message signal representing that the CDMA mode is provided. One of example cases where the GAM signal is received in the standby status in the AMPS is that the service area including the radio base station providing the CDMA mode is adjacent to a service area providing only the AMPS mode.

All radio base stations providing the CDMA mode also provide communication services in the AMPS mode. Therefore, it is possible to forecast whether a radio wave in the CDMA mode can be transmitted and received without fail based on the level of the wave strength in the AMPS mode.

If the detected wave strength is at a predetermined level or higher, the mobile telephone apparatus searches for a control channel in the CDMA mode (54). When the mobile telephone apparatus seizes a control channel, the apparatus receives a control signal transmitted over the control channel (55). The mobile telephone apparatus executes location registration in the radio base station to register the service area where the apparatus is located, and transmits a location registration message signal to the radio base station (56). The radio base station, which has received the location registration message signal from the mobile telephone apparatus, transmits to the mobile telephone apparatus an ACK signal (acknowledge signal) representing that the location registration message signal from the mobile telephone apparatus is correctly received. When the mobile telephone apparatus 4 receives the ACK signal (57), the location registration is completed and the mobile telephone apparatus is put in the standby status in the CDMA mode (58).

If the detected wave strength is lower than the predetermined level, the mobile telephone apparatus is not shifted to a status for receiving a signal in the CDMA mode, and maintained in the standby status in the AMPS mode (51).

FIG. 6 is a diagram showing a display screen of the display unit shown in FIG. 4. A receiving status is indicated by a bar indicator 62 based on the RSSI signal of the wave received by the receiving unit (Rx) 404. A mark 63 indicates a communication mode used by the mobile telephone apparatus. The mark 63 is not lit in the AMPS mode, and lit in the CDMA mode. A mark 64 indicates a call status. The mark 64 is lit only while a call is in progress. A battery indicator 65 indicates a remaining amount of charge of the battery. The more the lit portion of the battery indicator 65 is lit, the more the remaining amount of charge of the battery is large.

Whether the mobile telephone apparatus is maintained in the AMPS mode or switched to the CDMA mode is determined depending on the level of the wave strength of the signal received in the AMPS mode, for example, as follows. As shown in FIG. 6, then a display 61 of the display unit 52 indicates less than three bars in the bar indicator 62, the standby status in the AMPS mode is maintained (51). On the other hand, the number of bars indicated in the bar indicator 62 is three or more, the mobile telephone apparatus executes the control for searching for a control channel in the CDMA mode (54).

As described above, the mobile telephone apparatus can select whether a signal is to be received in the AMPS mode or the CDMA mode depending on the level of the wave strength of the signal received in the AMPS mode.

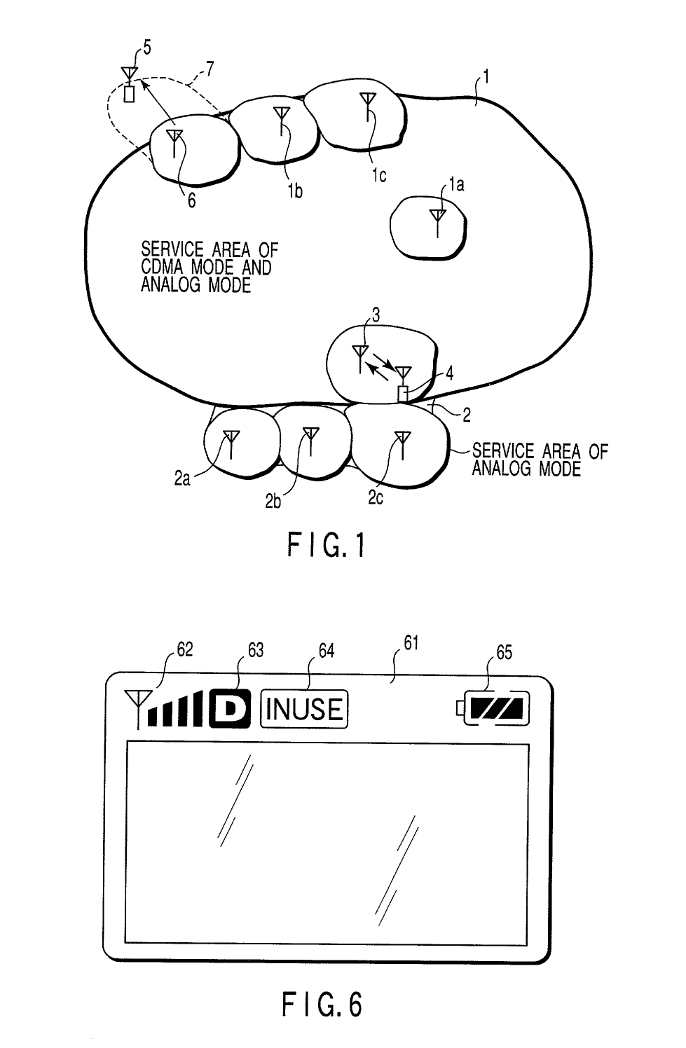

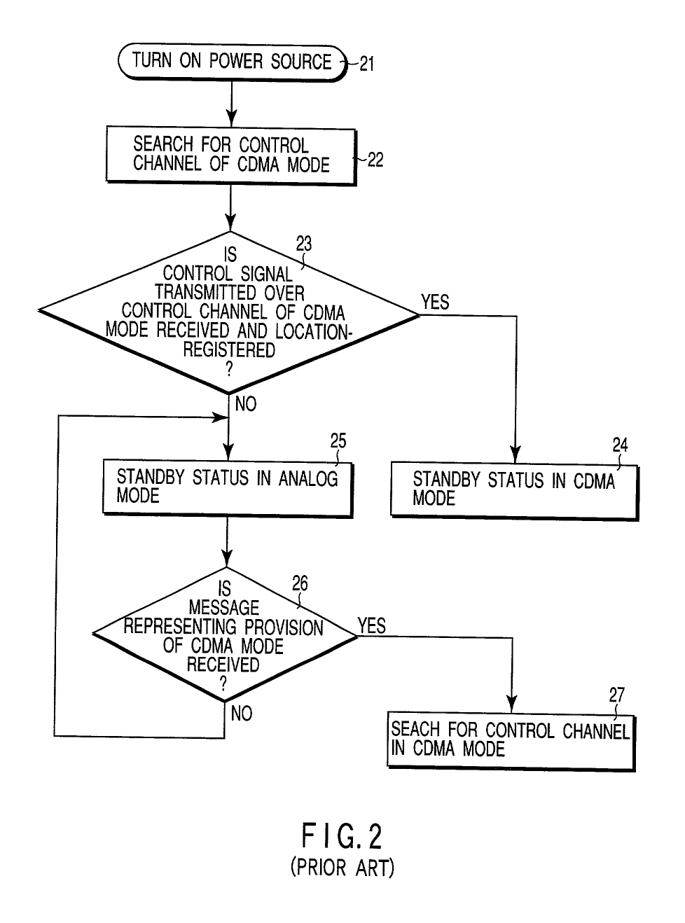

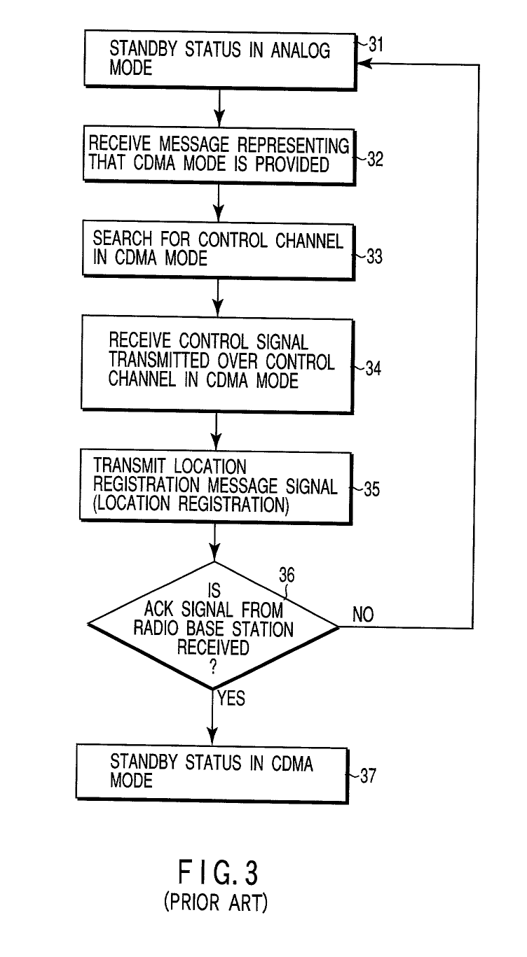

Therefore, in the transmission or reception unstable service area as shown in FIG. 1 in which the mobile telephone apparatus 5 can receive a signal from the radio base station 6, whereas a wave transmitted from the mobile telephone apparatus 5 cannot reach the base station 6 during the standby status in the CDMA mode, since the level of the wave strength of the signal received by the mobile telephone apparatus 5 in the AMPS mode is low, the mobile telephone apparatus 5 determines that the level of the wave strength is not at the predetermined level or higher, and maintains the standby status in the AMPS mode (51).

Therefore, it is possible to solve the problem that the mode of communication services in the mobile telephone apparatus 5 is alternated between the AMPS mode and the CDMA mode, the location registration cannot be performed and an outgoing call or an incoming call cannot be made.

Moreover, since the mobile telephone apparatus 5 need not transmit the location registration message signal many times for location registration, power consumption of the battery can be reduced.

In the above embodiment, the AMPS mode and the CDMA modes are described as examples of the analog mode and the digital mode respectively. However, the present invention is not limited to these modes but can be applied to the other analog modes and digital modes in the same manner.

According to the present invention having the above constitution, when the mobile telephone apparatus receives from a radio base station a message signal representing that a digital mode (e.g., the CDMA mode) is provided, it does not search for a control channel in the digital mode unconditionally. The mobile telephone apparatus detects the wave strength of a signal received in the analog mode, and selects whether it should search for a control channel in the digital mode or should be placed in the analog mode depending on the level of the wave strength of the received signal. Therefore, with the mobile telephone apparatus of the present invention, in a service area in which the transmission or reception condition is unstable, it is possible to solve the problem that the mode of communication services in the mobile telephone apparatus is alternated between the analog mode and the digital mode and an outgoing call or an incoming call cannot be made.

As described above, when the mobile radio communication apparatus of the present invention receives from a radio base station a message signal representing that a digital mode is provided, it detects the wave strength of a signal received in the analog mode. If the detected wave strength is at a predetermined level or higher, the mobile radio communication apparatus searches for a control channel in the digital mode. On the other hand, if the detected wave strength is lower than the predetermined level, the mobile radio communication apparatus is not shifted into the digital mode but maintains the standby status in the analog mode.

Therefore, in a service area in which the transmission or reception condition is unstable, if the mobile radio communication apparatus receives the aforementioned message signal, it selects a suitable reception mode, either the analog mode or the digital mode. Consequently, the present invention can provide a mobile radio communication apparatus which can perform stable communication by suitably selecting either the analog mode or the digital mode, so that both an outgoing call and an incoming call can be performed successfully.

Moreover, the present invention can provide a mobile radio communication apparatus in which a location registration message signal need not be transmitted many times for location registration, so that power consumption of the battery can be reduced.

Additional advantages and modifications will readily occur to those skilled in the art. Therefore, the invention in its broader aspects is not limited to the specific details and representative embodiments shown and described herein. Accordingly, various modifications may be made without departing from the spirit or scope of the general inventive concept as defined by the appended claims and their equivalents.

What is claimed is:

1. A mobile radio communication apparatus, having a communication function adaptable to both an analog mode and a digital mode, for carrying out communications with one of radio base stations capable of communicating in at least the analog mode, said apparatus comprising:
signal receiving means for receiving a signal representing that a communication can be carried out in the digital mode from a radio base station capable of communicating in both the analog mode and the digital mode, the signal being received in the analog mode;
detecting means for detecting a strength of the signal received from the radio base station; and
shifting means for shifting a mode of communication services into the digital mode from the analog mode in accordance with the strength, when the signal is received.

2. A mobile radio communication apparatus according to claim 1, wherein the shifting means shifts the mode of communication services into the digital mode when the strength is at a predetermined level or higher, and maintains the analog mode when the strength is lower than the predetermined level.

3. A mobile radio communication apparatus according to claim 1, wherein the digital mode is the CDMA mode.

4. A mobile radio communication apparatus according to claim 1, wherein the analog mode is the AMPS mode.

5. A mobile radio communication apparatus according to claim 1, wherein the signal is an analog signal.

6. A mobile radio communication apparatus according to claim 1, wherein said shifting means includes transmitting means for transmitting to the radio base station a location registration signal for registering a location of the mobile radio communication apparatus in order to establish a communication in the digital mode in accordance with the strength.

7. A mobile radio communication apparatus according to claim 6, wherein said shifting means further includes:
seizing means for seizing a control channel for controlling a communication in the digital mode in accordance with the strength; and
control signal receiving means for receiving a control signal on the sized control channel, the control signal being transmitted from the radio base station.

8. A control method for controlling a mobile radio communication apparatus having a communication function adaptable to both an analog mode and a digital mode and a function for receiving, from a radio base station in the analog mode, a signal representing that a communication can be carried out in the digital mode, said method comprising the steps of:
detecting a strength of the message signal received from the radio base station; and
shifting a mode of communication services into the digital mode from the analog mode in accordance with the strength, when the message signal is received.

9. A control method according to claim 8, wherein the mode of communication services is shifted into the digital mode when the strength is at a predetermined level or higher, and the analog mode is maintained when the strength is lower than the predetermined level.

10. A control method according to claim 8, wherein the digital mode is the CDMA mode.

11. A control method according to claim 8, wherein the analog mode is the AMPS mode.

12. A control method according to claim 8, wherein the signal is an analog signal.

13. A control method for controlling a mobile radio communication apparatus having a communication function adaptable to both an analog mode and a digital mode and a function for receiving, from a radio base station in the analog mode, a signal representing that a communication can be carried out in the digital mode, said method comprising the steps of:
detecting a strength of the signal received from the radio base station; and
performing a control for transmitting to the radio base station a location registration signal for registering a location of the mobile radio communication apparatus in order to establish a communication in the digital mode in accordance with the strength, when the signal is received.

14. A control method according to claim 13, further comprising the steps of:
seizing a control channel for controlling a communication in the digital mode in accordance with the strength; and
receiving a control signal on the control channel, the control signal being transmitted from the radio base station.

15. A control method according to claim 13, wherein a mode of communication services is shifted to the digital mode when the strength is at a predetermined level or higher, and the analog mode is maintained when the strength is lower than the predetermined level.

16. A control method according to claim 13, wherein the digital mode is the CDMA mode.

17. A control method according to claim 13, wherein the analog mode is the AMPS mode.

18. A control method according to claim 13, wherein the signal is an analog signal.

19. A control method for controlling a mobile radio communication apparatus adaptable to both an analog mode and a digital mode, for carrying out a communication with a radio base station capable of carrying out a communication at least in the analog mode, said method comprising the steps of:
receiving, from the radio base station in the analog mode, a message signal representing that a communication can be carried out in the digital mode;
detecting a strength of the signal received from the radio base station; and
shifting a mode of communication services into the digital mode in accordance with the strength, when the signal is received.

20. A control method according to claim 19, wherein, in said shifting step, the mode of communication services is shifted into the digital mode when the strength is at a predetermined level or higher, and the analog mode is maintained when the strength is lower than the predetermined level.

21. A control method according to claim 19, wherein the digital mode is the CDMA mode.

22. A control method according to claim 19, wherein the analog mode is the AMPS mode.

23. A control method according to claim 19, wherein the signal is an analog signal.

24. A control method according to claim 19, wherein said shifting step includes a step of transmitting to the radio base station a location registration signal for registering a location of the mobile radio communication apparatus in order to establish a communication in the digital mode in accordance with the strength.

25. A mobile radio communication apparatus according to claim 24, wherein said shifting step further includes the steps of:
seizing a control channel for controlling a communication in the digital mode in accordance with the strength; and
receiving a control signal on the control channel, the control signal being transmitted from the radio base station.
